(19) United States
(12) Patent Application Publication
(10) Pub. No.: US 2006/0288036 A1
(43) Pub. Date: Dec. 21, 2006

(54) Device specific content indexing for optimized device operation

(75) Inventors: Vladimir Sadovsky, Bellevue, WA (US); Stephen R. Handley, Bellevue, WA (US); Oren Rosenbloom, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/155,433

(22) Filed: Jun. 17, 2005

(51) Int. Cl. G06F 7/00

(52) U.S. Cl. 707/102

(57) ABSTRACT

Generation of an index database that is customized for a specific responder device using device parameters of the responder device is provided. The index database is generated on a device other than the responder device. In accordance with one method, an indication of a selection of objects is received. Device parameters of the responder device are also accessed. An index database is generated for the selection of objects using the device parameters of the responder device. The index database may then be transferred to the responder device.

### CROSS-REFERENCE TO RELATED APPLICATIONS

The subject matter of this application is related to the subject matter of co-pending U.S. patent application Ser. No. 10/429,116 filed May 2, 2003 entitled “System and Method for Facilitating Communication Between a Computing Device and Multiple Categories of Media Devices,” assigned or under obligation of assignment to the same entity as this application.

### STATEMENT REGARDING FEDERALLY SPONSORED RESEARCH OR DEVELOPMENT

Not Applicable.

### BACKGROUND

With the rapid digitization of content, such as music, videos, and photos, the personal home computer is often the primary place for storing and organizing the content. However, consumption of content frequently occurs on less capable devices, such as media devices, for example. In a typical scenario, a user connects a media device to the user's PC, transfers media content to the device, and then uses the media device to access the content. For example, a user may transfer a number of songs from the user's PC to a portable audio player and then listen to the songs using the portable audio player as opposed to the PC.

As consumption of content using these less capable devices (e.g., media devices) increases, the storage capacity of the devices also continues to grow. However, such devices typically remain constrained by limited processing power, RAM, and power supply. Such constraints often affect users' experiences with the devices because, for example, users may not be able to quickly browse and access the large amount of content stored on the devices.

To improve the operation of a device, an index database or accelerator that allows quicker browsing and access may be generated for content stored on the device. However, current approaches to index database creation present a number of shortcomings. One approach would be generation of an index database by the constrained device during content transfer from a PC. Because the devices are constrained by limited processing power and RAM, generation of an optimized index database may require an extensive amount of time during content transfer that is unacceptable to most users. As a result, some devices may generate only a limited index database, leading to a less than optimal user experience. Another approach would be generation of an index database on the PC, which may then transfer the index database to the device when transferring the content. However, such index databases are generic in nature and are not optimized or customized for the individual device for which the content is destined.

The quality of user experience may also be affected by the protocol session between two devices, such as between a constrained device and a PC, for example. The session may involve a number of processes, such as enumeration of content on each device, navigation between containers in hierarchal structure, and efficient metadata retrieval based on user queries. Thus, user experience could also be enhanced by providing optimization for the transfer enumeration protocol between the two devices.

### BRIEF SUMMARY

Embodiments of the present invention relate to using device parameters of a responder device to generate, at an initiator device, an index database that is customized for the responder device. The index database may also be optimized for the specific protocol used to communicate between the initiator device and responder device.

Accordingly, in one aspect, an embodiment of the invention is directed to a method at an initiator device for generating an index database. The method includes receiving an indication of a selection of at least one object. The method also includes accessing at least one device parameter of a responder device. The method further includes generating an index database for the at least one object based on the at least one device parameter of the responder device and then transferring the index database to the responder device.

In another aspect of the invention, an embodiment relates to a method for dynamically generating, at an initiator device, an index database. The method includes accessing at least one device parameter of a responder device. The method also includes building a virtual model of the responder device using the at least one device parameter. The virtual model represents operation of the responder device in a disconnected state. The method further includes generating an index database for a selection of at least one object using the virtual model of the responder device.

In a further aspect, an embodiment of the present invention is directed to a system for generating an index database for a selection of at least one object. The index database is generated based on at least one device parameter of a responder device. The system includes an object selection component, a device parameter component, and an optimization engine component. The object selection component is capable of receiving an indication of a selection of at least one object. The device parameter component is capable of accessing at least one device parameter of the responder device. The optimization engine component is capable of generating an index database for the selection of at least one object, wherein the index database is generated using the at least one device parameter of the responder device.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a block diagram illustrating an exemplary system in accordance with an embodiment of the present invention;

FIG. 3 is a flow diagram showing a method for generating an index database while an initiator device and responder device are connected in accordance with an embodiment of the present invention;

FIG. 4 is a flow diagram showing a method for generating an index database while a responder device is disconnected from an initiator device in accordance with an embodiment of the present invention; and

FIG. 5 is a flow diagram showing a method for using a removable storage card to communicate device parameter information, objects, and an index database between an initiator device and responder device in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems and methods for generating, on an initiator device, an index database for a selection of objects. The index database is generated using device parameters of a responder device such that the index database is device specific for the responder device, as opposed to a generic database that is not optimized for any specific device. The index database is optimized for the responder device by first communicating device parameters for the responder device to the initiator device. The initiator device may generate the optimized index database using those device parameters and then may transfer selected objects and the optimized index database to the responder device. If the responder device has generated a partial (or less optimized) index database for its internal use (e.g., the responder device may allow deleting or adding content while the devices are disconnected), the initiator device may be able to merge the responder device index database with the generated index database and transfer the optimized index database to the responder device. Further, the index database may have a standardized form such that any initiator device (including those that did not create the index database) are able to work with the index database, including reading, writing, and/or recreating the database, for example. Thus, upon subsequent connections of a responder device with any initiator device after an index database has been generated and transferred to the responder device, the connected initiator device may elect to read the index database from the responder device to facilitate quick enumeration, reading, writing, and/or recreation of the database.

Among other things, an index database generated in accordance with embodiments of the present invention allows for a number of optimizations. By way of example only and not limitation, the index database allows for optimized enumeration of content resident on the responder device for browsing, management, and playback of the content locally on the responder device. In addition, the index database allows for optimized enumeration of content resident on the responder device for browsing, management, and playback of the content on an initiator device (either the initiator device that generated the database or another device). Further, the index database allows for optimized transfer rate of content between devices and the optimization of synch logic for intelligent synchronization of content between devices. The invention further allows the same standardized software and class device driver on the initiator device to be used to optimize the functionality of a variety of connected responder devices, using the same protocol and database schema. In addition, the optimization may be tailored to the communication protocol used between the devices to provide enhanced operation during the connected session

Having briefly described an overview of the present invention, an exemplary operating environment for the present invention is described below.

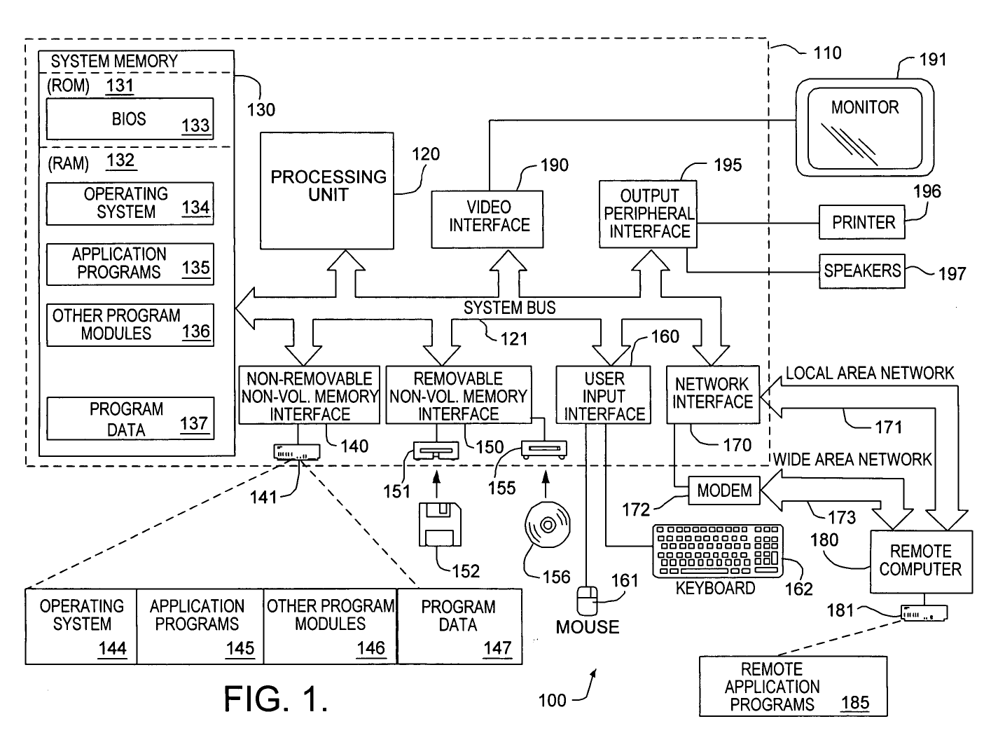

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

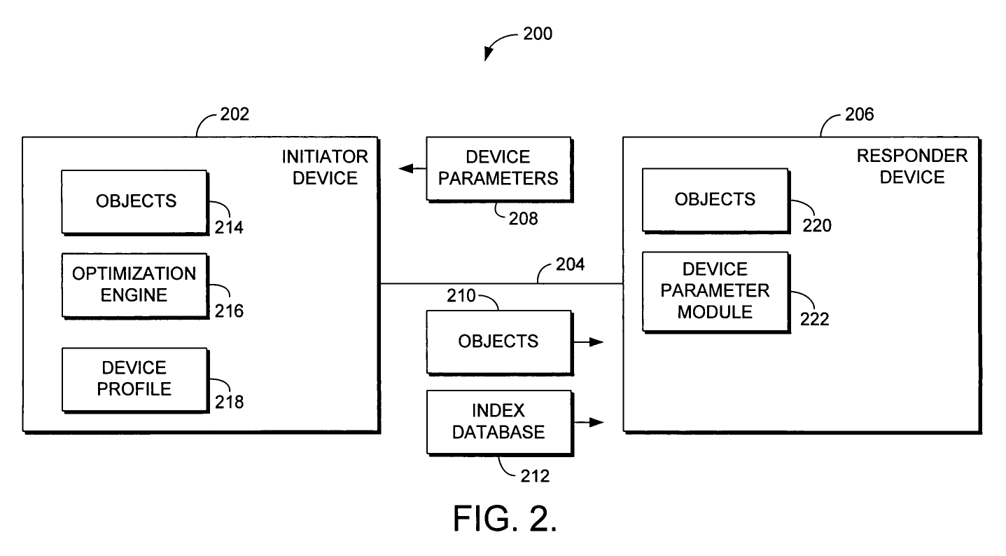

Turning to FIG. 2, a block diagram is illustrated which shows an exemplary system 200 in which embodiments of the present invention may be employed. The system 200 includes an initiator device 202 communicating over a communication link 204 with a responder device 206. In embodiments of the present invention, a user may operate the initiator device 202, for example via a user interface, to obtain device parameters 208 from the responder device 206 and initiate the transfer of objects 210 and an optimized index database 212 from the initiator device 202 to the responder device 206. Although the initiator device 202 typically functions to open a communication session with the responder device, it is possible that a role reversal may occur if a responder device 206 opens a communication session with the initiator device 202. In such an instance, the responder device 206 may be enhanced to include appropriate tools for opening and closing a session. Further, it should be understood that the initiator device 202 and responder device 206 may also operate in a peer to peer relationship within the scope of the present invention. Thus, in various embodiments of the invention, either or both of the initiator device 202 and the responder device 206 may manage communication between the devices.

The initiator device 202 may be a personal computer, such as the computer device 110 described above with reference to FIG. 1, a portable computer, or other computing device or machine. The initiator device 202 may host or contain a set of objects 214, encoding the audio, video, image, or other media or content stored thereon. The objects 214 may include, for example, audio objects (such as music, voice recordings or other audio content), digital photograph objects (such as those downloaded from a digital camera, a photo sharing or other Internet site, or other source), video objects (such as DV-compatible video clips), or objects containing other types of media or content (e.g., calendar information, contact information, or document files). Each object may include media or other content data (such as the sound file, digital photograph, or document file stored in a binary format) paired with a set of object properties or attributes describing the content data. For example, the properties may include a codec type, a color depth for color images, artist and play time for songs, or other attributes or characteristics. Such properties are often referred to as metadata.

The initiator device 202 also includes an optimization engine 216 that, for a given set of selected objects 210, may generate an index database 212 that is optimized for the responder device 206. In order to create an optimized index database 212, the optimization engine 216 accesses a set of device parameters for the responder device 206. A wide range of different device parameters may be employed to optimize the index database. By way of example only and not limitation, the device parameters may describe static hardware and software characteristics of the responder device 206, such as hard drive speed, amount of accessible main memory, main processor speed, and battery power sensitivity. In addition, the device parameters may include the responder device's 206 preference for particular record formats and placement of records into a database. Further, the device parameters used to optimize the index database may be dynamic properties, such as typical patterns of access and resultant performance information for the specific responder device 206. These dynamic parameters are typically measured by the responder device 206. Thus, the dynamic parameters are specific not only for a given device model, but to a particular instance, as there may be differences in physical characteristics between different instances of devices.

The optimization engine 216 may access device parameters for the responder device 206 in a number of ways within the scope of the present invention. In one embodiment, the optimization engine 216 may access a device profile 218 stored on the initiator device 202. The initiator device 202 may build and store the device profile 218, for example, after it obtains device parameters 208 from the responder device 206 the first time the devices are connected. Alternatively, the initiator device 202 may build and store the device profile 218 after it obtains device parameters from a different source, such as an on-line service keyed by an identification of the responder device 206. Once created, the device profile 218 may be updated each time the responder device 206 is connected to the initiator device 202 or may be periodically updated by an on-line service or other source. In another embodiment, the initiator device 202 may not maintain a device profile, such as the device profile 218, but instead dynamically obtains the device parameters 208 from the responder device 206 each time the devices are connected. Acquisition of device parameters from the responder device 206 may occur via a general purpose connectivity protocol, as indicated in further detail below.

Generally, the responder device 206 may be any type of device, portable or non-portable, capable of communicating with the initiator device 202. The responder device 206 may receive objects 210 and either present the content itself or further communicate the content to another device for presentation. By way of example and not limitation, the responder device 206 may be a digital still camera, a digital video camera (with or without still image capture functionality), a portable media player (such as a personal music player or a personal video player), an automotive media player, a cellular phone (with or without media capturing/playback capabilities), a personal data assistant (PDA), a network-enabled wireless device (such as a wireless email or other messaging device), a global positioning system (GPS) or other positioning device, an event recording device, a remotely controlled device, a telemetry device, an instrumentation device, an industrial device, a medical device, a portable storage device, or other device, player, or system.

The responder device 206 may also include a set of objects 220, similar to those described above with respect to the initiator device 202. For example, the set of objects 220 may have been previously transferred from the initiator device 202 or an alternative source of content. The responder device 206 may further include a device parameter module 222, which may maintain both static and dynamic device parameter information and provide the ability to communicate the information to the initiator device 202. To maintain dynamic device parameter information, the device parameter module 222 or another associated component may be able to collect a variety of performance data. For example, the device parameter module 222 or other component may track access to a previously transferred index database or to previously transferred objects and maintain performance counters. In addition, the device parameter module 222 may measure user interface parameters and parameters of communicating with other devices, such as the initiator device 202.

Although many internal components of the initiator device 202 and the responder device 206 are not shown, those skilled in the art will appreciate that such components and their interconnection are well known. Accordingly, additional details concerning the internal construction of the initiator device 202 and the responder device 206 are not further described herein.

The initiator device 202 and responder device 206 may communicate via the communication link 204. In one embodiment, the communication link 204 may be wireline, such as a universal serial bus (USB) connection or a FireWire™ connection. In another embodiment, the communication link 204 may be wireless, such as a BlueTooth™ or WiFi™ connection. In yet another embodiment, the communication link 204 may comprise a combination of wireline and wireless connections. Furthermore, the communication link 204 may be a direct connection or may comprise a network communication, including one or more LANs and/or WANs, such as those described above with reference to FIG. 1. In yet a further embodiment of the present invention, the responder device 206 may include a removable storage card, and the communication link 204 may represent connecting the storage card (as opposed to the responder device 206) with the initiator device 202 (e.g., for using the storage card to transfer objects, device parameters, and index databases between the two devices). It will be appreciated by those of ordinary skill in the art that the communication link 204 described herein is exemplary and other means of establishing communication between the initiator device 202 and responder device 206 may be utilized.

In accordance with embodiments of the present invention, the initiator device 202 and responder device 206 may be configured to communicate via a general purpose connectivity protocol, such as the Media Transfer Protocol (MTP). The MTP is, for example, further described in the aforementioned U.S. patent application Ser. No. 10/429,116. However, while description is made of media manipulation using the MTP, it will be appreciated that according to embodiments of the invention in a further regard, other protocols, layers, or schema may be used as or incorporated within the general purpose connectivity protocol.

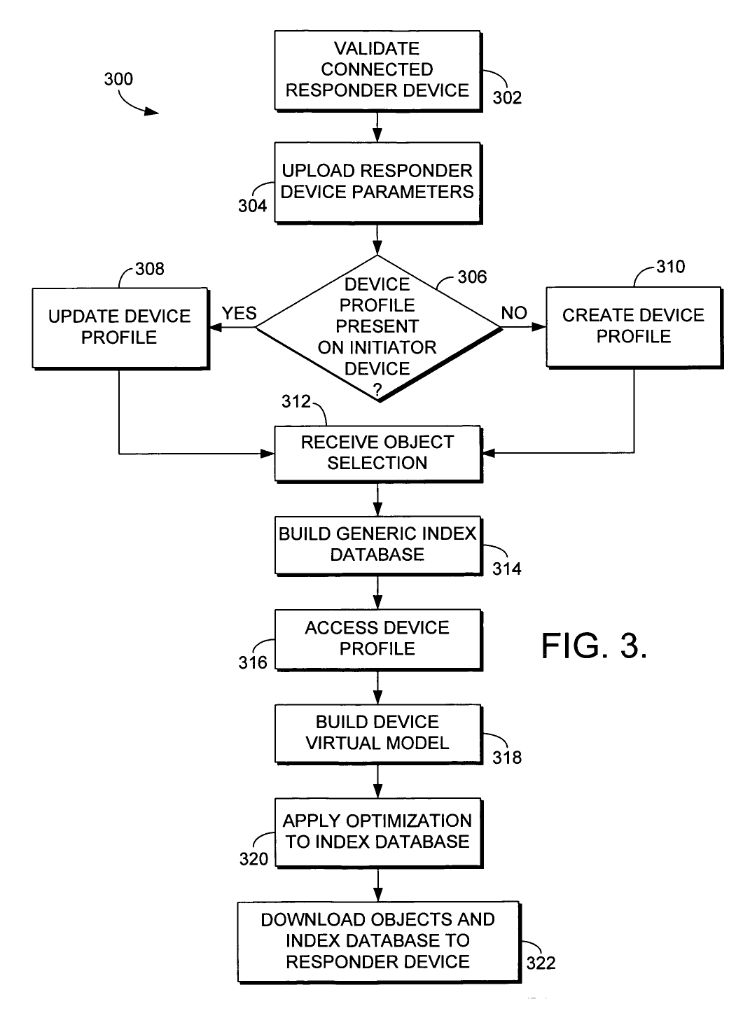

Referring now to FIG. 3, a flow diagram is illustrated which shows a method 300 for generating an optimized index database while the responder device 206 is connected to the initiator device 202 in accordance with embodiments of the present invention. Initially, the initiator device 202 validates the responder device 206 has been connected, as shown at block 302. The initiator device 202 then uploads any available device parameters from the responder device 206 at block 304. As mentioned previously, the device parameters may include, for example, static hardware and software characteristics, report format and placement preferences, and dynamic usage and performance information.

After obtaining device parameters from the responder device 206, the initiator device 202 determines whether it currently maintains a device profile for the responder device 206, as shown at block 306. The initiator device 202 may already store a device profile for the responder device 206, for example, if the devices have previously been connected or if the initiator device 202 previously obtained device parameters from another source, such as an on-line service providing such data. If a device profile for the responder device 206 is currently maintained, the initiator device 202 updates the device profile with the presently uploaded device parameters, as shown at block 308. Alternatively, if the initiator device 202 does not currently maintain a device profile for the responder device 206 (e.g., if the devices have never been connected before and no device parameters have otherwise been communicated to the initiator device 202), the initiator device 202 generates a device profile at block 310.

At block 312, the initiator device 202 receives a selection of objects for which an index database is to be created. Typically, the selection will include objects stored locally on the initiator device 202 that have been selected to be transferred to the responder device 206. However, in embodiments of the present invention, a user may wish to create an index database for objects currently stored on the responder device 206 or a combination of objects stored on both devices. In such embodiments, the responder device 206 transfers data regarding its selected objects to the initiator device 202. In any case, object selection may be based on either an explicit selection of objects by a user or as a result of dynamic queries against objects stores on either or both the initiator device 202 and the responder device 206.

After receiving the object selection, the initiator device 202 analyzes and processes the selection according to performance impacting characteristics to create a generic index database, as shown at block 314. At the same time, other processing may also be carried out. For example, intra-content pointers may be identified to assist with fine grain navigation when operating the responder device 206 after the objects and the index database have been downloaded (e.g., for scene detection for a video clip). Because the device parameters for the responder device 206 have not yet been employed, the initially constructed index database is generic and has not been optimized.

To optimize the index database for the responder device 206, the initiator device 202 accesses the device profile at block 316. Based on the collection of device parameters within the device profile, the initiator device 202 builds a virtual model of the responder device 206 that represents the operation of the responder device 206 in a disconnected state, as shown at block 318. At block 320, descriptive metadata associated with the selected objects may then be processed to optimize the index database.

Varying degrees of optimization may be achieved depending on the device parameters available to the initiator device 202 and in accordance with different embodiments of the present invention. For example, use of different static parameters may provide numerous points of optimization. In addition, if the responder device has preferences for particular record formatting and placement in the database and the preferences are indicated in the device profile, the index database may be optimized in accordance with those preferences. Dynamic data may be used to further optimize the index database based on how the responder device 206 actually operates when disconnected. For example, usage patterns and resultant performance information may dictate the optimal structure of the index database. Moreover, device components may wear out or be mislabeled, such that static parameters are insufficient to fully optimize. In further embodiments of the present invention, optimization of the index database may also include addressing of objects based on the responder device's 206 storage parameters. The object addressing may either be in hardware independent fashion (e.g., file system nodes) or in hardware dependent fashion (e.g., absolute numbers of disk sectors).

After the index database has been optimized for the responder device 206, the selected objects and optimized index database may be downloaded from the initiator device 202 to the responder device 206, as shown at block 322. In one embodiment, all selected objects are first downloaded to the responder device 206. Relative links are then resolved, if necessary, and the index database is then downloaded. In another embodiment, the index database is incrementally downloaded after groups of related objects (e.g., related by folder or playlist) are transferred to the responder device 206. In a further embodiment, the index database may contain placeholders for absolute addressing of objects on the responder device 206. The placeholders may be filled by the responder device 206 concurrently with object downloading, which may be a simpler operation for the responder device 206 to perform than constructing the entire index database.

After the responder device 206 has been disconnected from the initiator device 202 or a download session has been completed, the responder device 206 may perform a consistency validation. If the devices are still connected, the responder device 206 may report any error conditions to the initiator device 202, which may initiate an index database rebuild process. However, if the devices have been disconnected, the responder device 206 may rebuild the index database before first operation to enable device functionality as long as needed content had been downloaded.

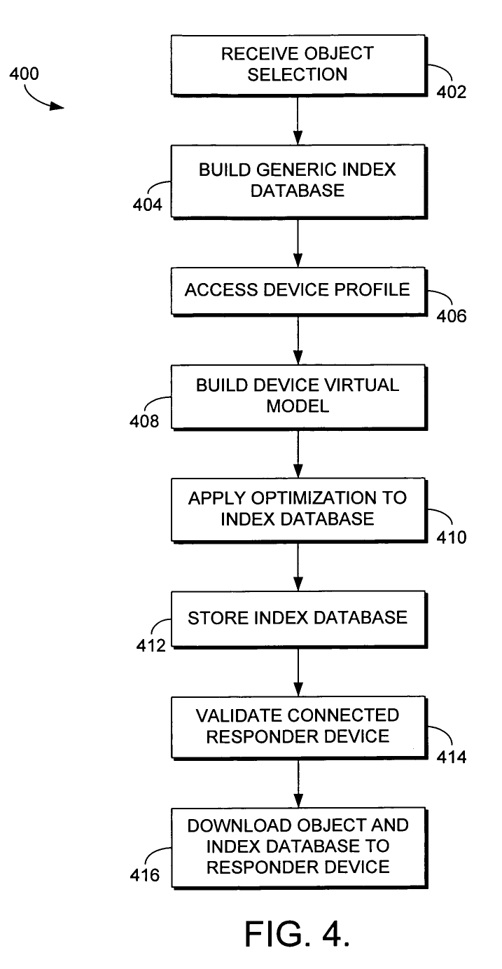

A user may wish to select objects while the initiator device 202 and the responder device 206 are disconnected and then transfer the content when the devices are later connected. If the initiator device 202 maintains a device profile, the initiator device 202 may generate an optimized index database for the selected objects prior to device connection. Turning to FIG. 4, a flow diagram is shown illustrating a method 400 for generating an index database while the responder device 206 is disconnected from the initiator device 202 in accordance with an embodiment of the present invention. The method 400 is similar to the method 300 previously described with the exception that the initiator device 202 must rely on device parameters provided in a locally stored device profile.

Initially, the initiator device 202 receives a selection of objects to be transferred to the responder device 206, as shown at block 402. As discussed above, the selection may be an express user selection or a dynamic query. Based on the selected objects, the initiator device 202 builds a generic index database at block 404. At block 406, the initiator device 202 next accesses the device profile to obtain device parameters. Using the device parameters from the device profile, the initiator device 202 builds a virtual model of the responder device 206 at block 408. The generic index database may then be optimized for the responder device 206 at block 410. At block 412, the initiator device 202 stores the optimized index database until the responder device 206 is connected. The index database, for example, may be stored as an atomic flat file. When the responder device 206 is later connected, the initiator device 202 validates the connection, as shown at block 414. The selected objects and optimized index database are then downloaded to the responder device 206 at block 416. In a further embodiment, the initiator device 202 may also access device parameters from the responder device 206 when the two devices are connected. If the device parameters accessed from the responder device 206 differ from the device profile maintained on the initiator device 202, the initiator device 202 may update the index database in accordance with the differences prior to transferring the index database to the responder device 206.

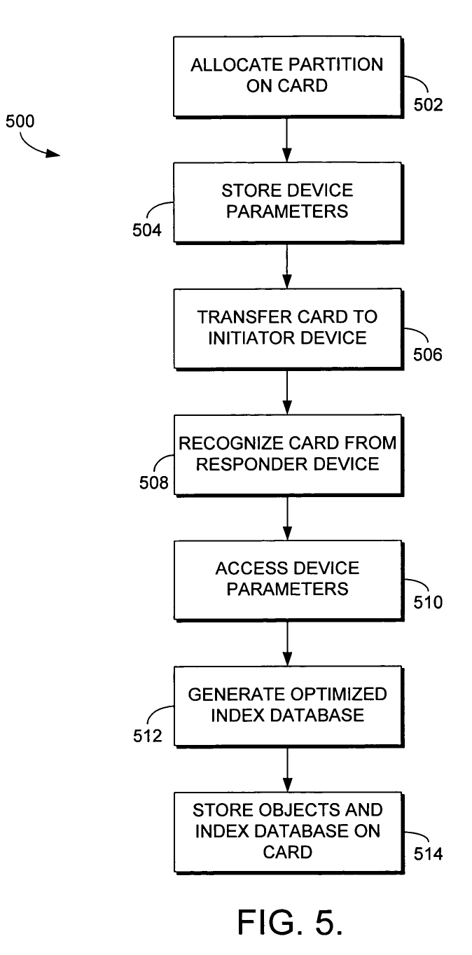

As mentioned previously, in embodiments of the present invention, the responder device 206 may employ a removable storage card. In such embodiments, device parameters for the responder device 206 may be communicated to the initiator device 202 using the storage card, and an optimized index database may be generated and stored on the storage card with selected objects. Referring to FIG. 5, a flowchart is illustrated that shows a method 500 for communicating responder device parameters, objects, and an optimized index database between the initiator device 202 and responder device 206 using a removable storage card in accordance with an embodiment of the present invention.

At block 502, the responder device 206 allocates a partition on the storage card to allow for storage of device parameters. The responder device 206 then stores any available device parameters within the partition at block 504. The responder device 206 may also store identification information for the device 206 within the partition (e.g., to allow use of the same storage card for multiple responder devices). As described previously, a wide variety of device parameters may be stored on the card, including, for example, static device hardware and software characteristics, record format and placement preferences, and dynamic usage and performance information. At block 506, the storage card is removed from the responder device 206 and inserted into the initiator device 202 or another component allowing communication between the initiator device 202 and the storage card.

After being connected with the storage card, the initiator device 202 recognizes that the card originates from a device capable of communicating its device parameters via the storage card, as shown at block 508. The initiator device 202 then accesses the device parameters located on the partition within the storage card at block 510. If no device profile exists for the responder device 206, a new profile is created. Otherwise, the existing device profile is updated. If the storage card contains information for multiple responder devices, the initiator device 202 may identify each responder device by device identification information provided within the partition for each device.

Using the device parameters, the initiator device 202 generates an optimized index database for a given selection of objects using a process similar to method 300 and 400 discussed with reference to FIG. 3 and FIG. 4, respectively, as shown at block 512. After generating the optimized index database, the initiator device 202 stores the selected objects and the generated index database on the storage card at block 514. The storage card may then be removed and transferred to the responder device 202.

As can be understood, embodiments of the present invention provide systems and methods for generating an index database that is optimized for a given device. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method at an initiator device for generating an index database, the method comprising:
receiving an indication of a selection of at least one object;
accessing at least one device parameter of a responder device;
generating an index database for the at least one object based on the at least one device parameter of the responder device; and
transferring the index database to the responder device.

2. The method of claim 1, wherein the at least one object is stored on at least one of the initiator device and the responder device.

3. The method of claim 1, wherein accessing at least one device parameter of the responder device comprises accessing a device profile containing at least one device parameter.

4. The method of claim 3, wherein the device profile is stored on the initiator device.

5. The method of claim 1, wherein accessing at least one device parameter of the responder device comprises communicating at least one device parameter from the responder device to the initiator device.

6. The method of claim 5, wherein communicating at least one device parameter comprises using a general purpose connectivity protocol.

7. The method of claim 6, wherein the general purpose connectivity protocol comprises the Media Transfer Protocol.

8. The method of claim 1, wherein the at least one device parameter of the responder device comprises at least one of a hardware parameter, a software parameter, a record format preference, a record placement preference, device usage information, and device performance information.

9. The method of claim 1, wherein the responder device comprises at least one of a portable device, a media device, an audio player device, a video player device, a digital camera device, a video camera device, a cellular telephone, and a personal data assistant.

10. The method of claim 1, wherein generating an index database comprises:
generating a generic index database based on the selection of at least one object; and
converting the generic index database to a device specific index database using the at least one device parameter for the responder device.

11. The method of claim 1, wherein the at least one object comprises at least one of a video media object, an audio media object, an image media object, and a document file object.

12. The method of claim 1, further comprising transferring the at least one object to the responder device.

13. The method of claim 1, wherein at least one of:
accessing at least one device parameter of the responder device; and
transferring the index database to the responder device;
comprises communicating between the initiator device and the responder device using at least one of a wired link, a wireless link, and a removable storage medium.

14. The method of claim 1, further comprising accessing an index database on the responder device; and
wherein generating an index database comprises generating a new index database based on the at least one device parameter of the responder device and the index database accessed from the responder device.

15. One or more computer-readable media having computer-useable instructions embodied thereon for performing the method of claim 1.

16. A method for dynamically generating, at an initiator device, an index database, the method comprising:
accessing at least one device parameter of the responder device;
building a virtual model of the responder device using the at least one device parameter, the virtual model representing operation of the responder device in a disconnected state; and
generating an index database for a selection of at least one object using the virtual model of the responder device.

17. The method of claim 16, wherein accessing at least one device parameter of the responder device comprises at least one of:
accessing a device profile containing at least one device parameter; and
communicating at least one device parameter from the responder device to the initiator device.

18. The method of claim 16, wherein generating an index database comprises:
generating a generic index database based on a selection of at least one object; and
employing the virtual model of the responder device to convert the generic index database to a device specific index database based on the at least one device parameter for the responder device.

19. One or more computer-readable media having computer-useable instructions embodied thereon for performing the method of claim 16.

20. A system for generating an index database for a selection of at least one object, the index database being generated based on at least one device parameter of a responder device, the system comprising:
an object selection component for receiving an indication of a selection of at least one object;
a device parameter component for accessing at least one device parameter of the responder device; and
an optimization engine component for generating an index database for the selection of at least one object, wherein the index database is generated using the at least one device parameter of the responder device.
